(19) United States
(12) Patent Application Publication
(10) Pub. No.: US 2003/0182381 A1
(43) Pub. Date: Sep. 25, 2003

(54) Electronic mail delivery refusal method, electronic mail delivery refusal device and storage medium recording a program enabling a computer to execute the method

(75) Inventor: Ikuma Motoe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/265,331

(22) Filed: Oct. 7, 2002

(30) Foreign Application Priority Data
Mar. 22, 2002 (JP) 2002-079969

(51) Int. Cl. G06F 15/16

(52) U.S. Cl. 709/206

(57) ABSTRACT

A provider device comprises a delivery refusal server. The delivery refusal server further comprises a computer identification information extracting unit and a delivery refusal judging unit. The computer identification information extracting unit extracts computer identification information identifying a computer in a network from the text of an electronic mail addressed to a user. The delivery refusal judging unit judges whether the electronic mail should be delivered, based on the extracted computer identification information. Thus, the delivery of electronic mail that the user does not want, can be effectively refused.

### BACKGROUND OF THE INVENTION

1. Field of the Invention

The present invention relates to an electronic mail delivery technology for distributing messages, such as characters, images and the like transmitted/received through a network (hereinafter called “electronic mail”), and in particular, it relates to a technology for refusing the delivery of electronic mails meeting specific conditions in the delivery of electronic mail.

2. Description of the Related Art

Recently, cellular phones and computers with functions to transmit/receive electronic mail are widely spread. Along with this, the number of users of electronic mail has been rapidly increasing. In such a situation, the amount of commercial electronic mails transmitted unilaterally from agents to users (unnecessary electronic mail, which are called as spam) has also been increasing. Such mail is sent to cellular phones particularly often.

Since such unnecessary commercial mail is troublesome for users of electronic mail, there are some network service providers (hereinafter called a “provider”) providing services for refusing the delivery of such unnecessary commercial mail as requested.

For example, according to some service, a user notifies a provider of sender's address of an unnecessary commercial mail. Subsequently, the provider does not deliver electronic mail with the designated sender's address to the user and returns the mail to the sender.

According to some service, a user notifies a provider of the domains of sender's address of his/her desired electronic mail. Then, the provider selects and delivers electronic mail from the designated domains to the user, based on the sender's address.

The technology described above for refusing the delivery of an electronic mail that a user does not want to receive has the following problems.

For example, sometimes an agent sending commercial mail has a mail server for sending/receiving electronic mail. In this case, even when the delivery of an electronic mail with some sender's address is set to be refused, the agent can send the electronic mail to the user again by modifying his/her electronic mail address and sending the electronic mail again. In this case, as a result, the setting to refuse the delivery of unnecessary electronic mail address by the provider and the modification of his/her electronic address by the agent are simply repeated alternately, and the delivery of such electronic mail cannot be effectively refused.

For example, an agent often has a plurality of domains and often sends his/her commercial electronic mail from each of the domains. Therefore, when the setting to deliver the desired electronic mail having the designated domain in the sender's address is performed, if commercial electronic mail from the agent has the same domain in the sender's address as the designated domain, the delivery of the commercial electronic mail from the agent can not be effectively refused. Further, by the setting, electronic mail that the user can receive is limited to electronic mail with the designated domain in the sender's address. It is inconvenient for the user. If many domains are to be designated, the user must designate each of the domains one by one.

### SUMMARY OF THE INVENTION

It is an object of the present invention for a user to effectively refuse the delivery of unnecessary electronic mail by solving the problems described above.

According to one aspect of the present invention, an electronic mail delivery judging method for judging whether electronic mail should be delivered comprises: extracting a first computer identification information for identifying a computer in a network from the text of a first electronic mail, and judging whether the first electronic mail should be delivered, based on the extracted first computer identification information.

Most electronic mails that users want to refuse to receive are commercial mail, and the aim of the commercial mail is to urge users to visit a specific Web page. Therefore, most of the text of such a commercial mail includes information needed to access the specific Web page. By extracting computer identification information from the text of the first electronic mail, based on the information needed to access the specific Web page and judging whether the first electronic mail should be delivered, based on the extracted computer identification information, the problem described above can be solved. For such computer identification information, a domain, an Internet protocol address or the like can be used.

The method described above may further comprise: extracting a second computer identification information from the text of a second electronic mail, and judging whether the first electronic mail should be delivered, based on the first and second computer identification information.

More specifically, for example, if the second electronic mail is the electronic mail which is designated not to be delivered by the user, the computer identification information extracted from the second electronic mail can also be used to judge whether the first electronic mail should be delivered.

In the method described above, if the first and second computer identification information are the same, it can also be judged that the first electronic mail should not be delivered.

Further, the method described above may further comprise: obtaining first and second registration information about a computer in a network can based on the first and second computer identification information, respectively, and judging whether the first electronic mail should be delivered, based on the first and second registration information.

For example, sometimes if the sender of an unnecessary electronic mail has a plurality of pieces of computer identification information, the delivery of the unnecessary electronic mail from the sender cannot be effectively refused. On the other hand, registration information about a computer in a network is registered in a network information center or the like corresponding to the computer identification information.

Since this registration information like computer identification information is managed by the network information center or the like, the sender cannot easily modify the information. Therefore, when it cannot be judged whether an electronic mail from the sender should be delivered based on the computer identification information, it can be effectively judged whether the electronic mail should be delivered by obtaining and using registration information corresponding to the computer identification information. Such registration information can also be obtained using, for example, a Whois protocol.

Further, in the case of the judgment based on the first and second registration information, if the first and second registration information are at least partially the same, it can be judged that the first electronic mail should not be delivered.

According to another aspect of the present invention, a delivery refusal judgment device comprises a computer identification information extracting unit extracting a first computer identification information identifying a computer in a network from the text of a first electronic mail and a delivery refusal judgment unit judging whether the first electronic mail should be delivered, based on the extracted first computer identification information. Such a delivery refusal judgment device can also solve the problem described above.

The problem described above can also be solved by executing a program enabling a computer to perform the same procedures as performed by the electronic mail delivery refusal judgment method. Furthermore, the problem described above can also be solved when a computer reads and executes the program from a computer-readable storage medium on which the program is recorded.

Further, a method for receiving electronic mails in a network terminal connected to a delivery refusal judgment device through a network comprises: sending the text of a first electronic mail to the delivery refusal judgment device judging whether each electronic mail should be delivered and receiving a second electronic mail that the delivery refusal judgment device has judged to be delivered, based on computer identification information identifying a computer in the network, extracted from the text of the first electronic mail. Thus, the problem described above can also be solved.

### BRIEF DESCRIPTION OF THE DRAWINGS

The features and advantages of the present invention will be more clearly appreciated from the following description taken in conjunction with the accompanying drawings in which like elements are donated by like reference numerals and in which:

FIG. 1 shows the configuration of the electronic mail delivery system;

FIG. 2 shows the configuration of the provider device;

FIG. 3 shows an example of the data structure of the delivery refusal database;

FIG. 4 shows an example of the data structure of the registration information database;

FIG. 5 is a flowchart showing the rough process of the electronic mail delivery system (No. 1);

FIG. 6 is a flowchart showing the rough process of the electronic mail delivery system (No. 2);

FIG. 7 is a flowchart showing the registration process of an electronic mail, the delivery of which is refused (No. 1);

FIG. 8 is a flowchart showing the registration process of an electronic mail, the delivery of which is refused (No. 2);

FIG. 9A shows an example of a commercial mail, including a URL in the text, and FIG. 9B shows an example of a commercial mail, including an IP address in the text.

FIG. 10 shows an example of registration information;

FIG. 11 is a flowchart showing the process of judging whether an electronic mail should be delivered (No. 1);

FIG. 12 is a flowchart showing the process of judging whether an electronic mail should be delivered (No. 2);

FIG. 13 shows the configuration of the computer; and

FIG. 14 shows storage media and a transmission signal for providing the computer with data and a program.

### DESCRIPTION OF THE PREFERRED EMBODIMENTS

The preferred embodiments of the present invention are described below with reference to the drawings. The same reference numerals are attached to the same devices and units throughout the description and their descriptions are also omitted.

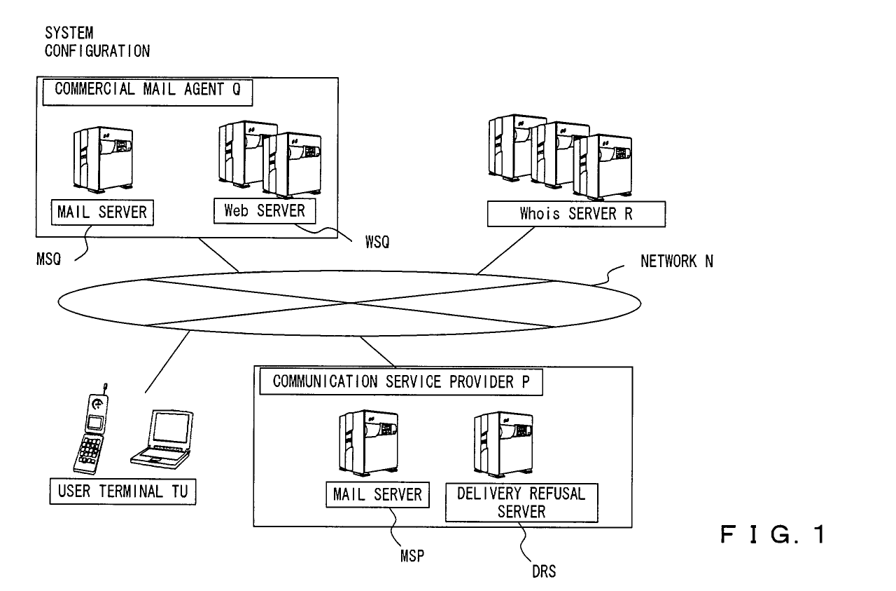

FIG. 1 shows the configuration of the electronic mail delivery system according to the preferred embodiment of the present invention. As shown in FIG. 1, the electronic mail delivery system comprises a user terminal TU used by a user U, a provider device P, a commercial mail agent device Q and a Whois server R, and the devices are connected to one another through a network N.

The network N can be a single network or a combination of a plurality of networks. For the network N, WAN (wide area network) like the Internet, a telephone network and wireless networks or the like, and LAN (local area network) can be used.

The user terminal TU is owned by the user U of electronic mail. The user terminal TU has at least a function to receive electronic mails. For the user terminal TU, a cellular phone, a PHS (personal handy-phone), an electronic notebook, a PDA (personal digital assistant), a portable data terminal, such as a palm-top/lap-top computer, etc., or a desk-top computer can be used. If there is an electronic mail that the user U wants to refuse to receive (inmost cases, commercial mail), the user U transfers the electronic mail to a mail server MSP comprised in the provider device P together with an instruction to refuse to receive it.

The provider device P comprises the mail server MSP and a delivery refusal server DRS. The mail server MSP delivers electronic mails to the user terminal TU, commercial mail agent Q and the like through the network N. The delivery refusal server DRS performs processes concerning delivery refusal, which is described in detail later.

The commercial agent device often comprises a mail server MSQ and a Web server WSQ. The commercial mail agent device Q generates commercial mails addressed to electronic mail users and transmits the mails to the user terminals TU through the network N using the mail server MSQ. The text of each commercial mail to be transmitted often includes the advertisement of a some Web site or stores a link to some Web site. The Web server WSQ stores a Web page served at the Web site that is advertised in the commercial mail, and transmits the Web page to the Web clients through the network N according to the instruction of each Web client.

Although FIG. 1 shows, for example, the configuration in which a commercial mail agent device Q comprises a mail server MSQ and a Web server WSQ, the present invention is not limited to this configuration. For example, a commercial mail agent Q with a mail server MSQ can transmit commercial mails in response to the request of another agent with a Web server WSQ.

Although the term “a commercial mail agent” is used, electronic mail to be refused for delivery is not limited to commercial mail, nor is the sender of electronic mail limited to an agent.

The Whois server R comprises a database storing registration information that is registered in a NIC (network information center) and the like for the purpose of network management, which is not shown in FIG. 1. The registration information includes computer identification information identifying a computer in the network, the name of the person who is registered as the manager of the computer (registrant), its electronic mail address, phone number and postal address and the like.

Any person connected to the network N can search for information stored in the database of the Whois server R using the Whois protocol. Although in this preferred embodiment, the registration information can be obtained by retrieving data from the database of the Whois server R, Whois server R is not needed as long as the same registration information can be obtained otherwise.

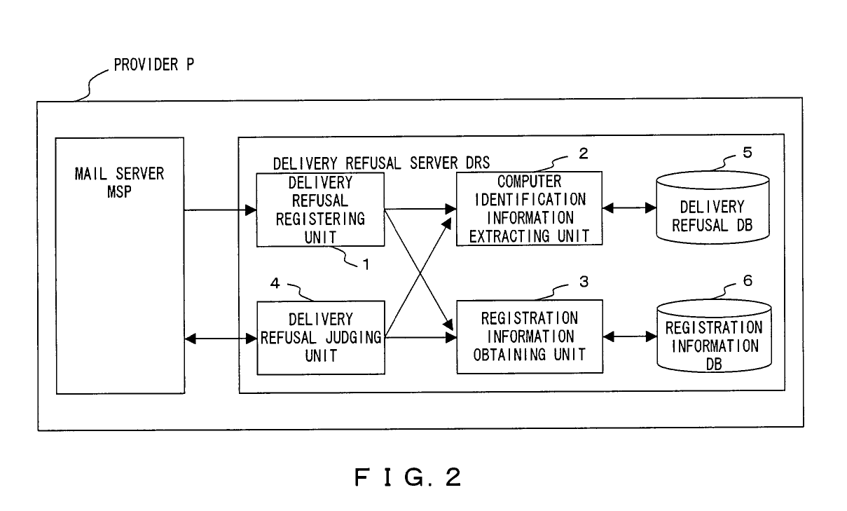

The configuration of the provider device P is described in detail below with reference to FIG. 2. As described above, the provider device P comprises a mail server MSP and a delivery refusal server DRS. On receipt of an instruction to refuse to receive electronic mail from a user U, the mail server MSP instructs the delivery refusal server DRS to register the delivery refusal. After the registration process, the mail server MSP instructs the delivery refusal server DRS to judge whether electronic mail should be delivered before sending the electronic mail to the user U.

The delivery refusal server DRS registers the delivery refusal of the electronic mail that the user U has instructed to refuse to deliver and judges whether the delivery of the electronic mail should be refused. For that purpose, as shown in FIG. 2, the delivery refusal server DRS comprises a delivery refusal registration unit 1, a computer identification information extracting unit 2, a registration information acquisition unit 3, a delivery refusal judgment unit 4, a delivery refusal database 5 (hereinafter a database is abbreviated to a DB) and a registration information database (DB) 6.

The delivery refusal registration unit 1 receives instructions to refuse to deliver and electronic mail, the reception of which are to be refused, from the mail server MSP.

The computer identification information extracting unit 2 extracts computer identification information identifying a computer in a network from the text of the electronic mail. If the computer identification information extracted from the text of the electronic mail is not stored in the delivery refusal DB 5 yet, the delivery refusal registration unit 1 writes the extracted computer identification information in the delivery refusal DB 5. For the computer identification information, a URI (uniform resource identifier) or a URL (uniform resource locator), an IP (Internet protocol) address or the like is used.

The registration information acquisition unit 3 obtains registration information about a computer identified by the computer identification information, from the DB of the Whois server R, using the computer identification information extracted by the computer identification information extracting unit 2 and writes the obtained registration information in the registration information DB 6.

The delivery refusal judgment unit 4 receives electronic mail and instructions to judge whether the electronic mail should be delivered from the mail server MSP, and judges whether the electronic mail should be delivered based on the instructions. This judgment is made in two steps. First, the delivery refusal judgment unit 4 judges whether the electronic mail should be delivered, based on the computer identification information extracted from the electronic mail. If the judgment cannot be made based on only the computer identification information, the delivery refusal judgment unit 4 further judges whether the electronic mail should be delivered, based on the registration information obtained using the computer identification information.

The delivery refusal judgment unit 4 notifies the mail server MSP of the result of the judgment. If the electronic mail is determined to be delivered by the delivery refusal judgment unit 4, the mail server MSP sends the electronic mail to the user U according to the recipient's address. If the electronic mail is determined to be refused for delivery, the mail server MSP returns the electronic mail to the commercial mail agent P according to the sender's address, or discard the electronic mail.

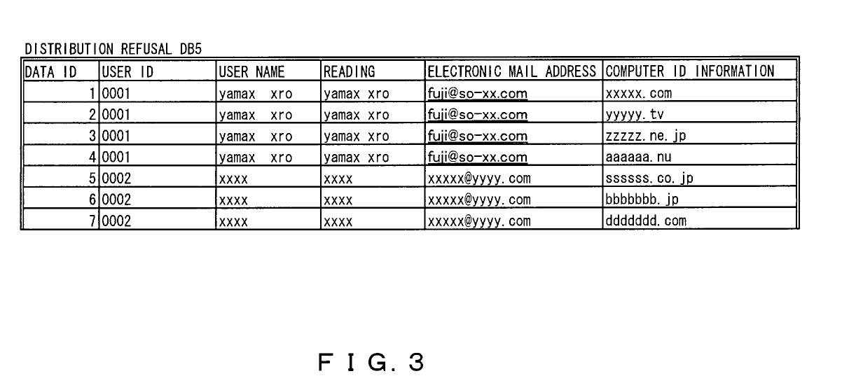

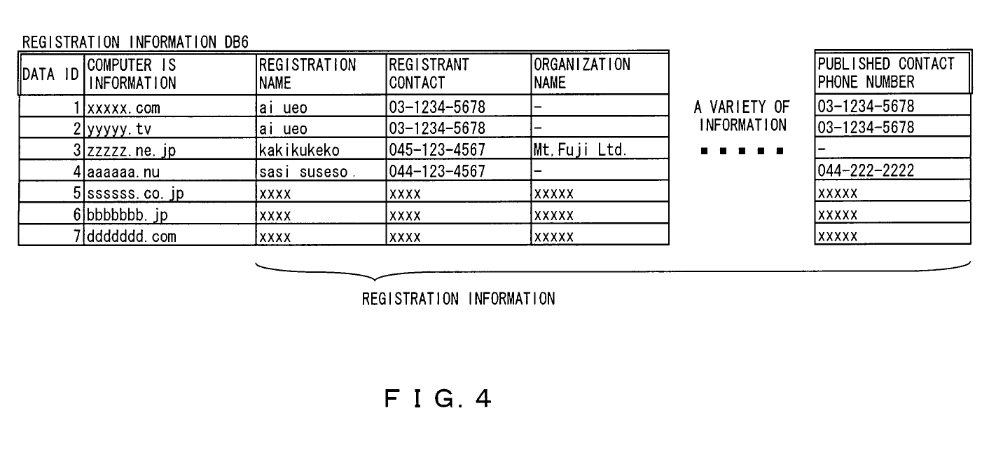

The respective data structures of the delivery refusal DB 5 and registration information DB 6 are described below with reference to FIGS. 3 and 4, respectively. FIG. 3 shows an example of the data structure of the delivery refusal DB 5. The delivery refusal DB 5 stores the delivery refusal data about the electronic mail that the user U has refused to receive. The delivery data includes a data ID, a user ID, a user name, kana letters of the user name, an electronic mail address and computer identification information. In the case of a language using a phonogram (alphabet), such as English and the like, kana letters of a user name is unnecessary. The user ID and user name are information identifying a user U that has refused to receive an electronic mail. The electronic mail address is the address of the user U that has refused to receive an electronic mail. The computer identification information is extracted from the text of the electronic mail to be refused to be received by the computer identification information extracting unit 2. These pieces of information are written in the delivery refusal DB 5 when a user's instruction to refuse to receive an electronic mail is received.

For example, according to FIG. 3, delivery refusal data of which data ID is 1, is registered according to instructions of delivery refusal from a user “yamax xrou”, the user ID of which is 0001, and computer identification information “xxxxx.com” is extracted from the text of an electronic mail, the delivery of which is refused. Furthermore, since a plurality of pieces of delivery refusal data with data IDs 2 through 4 also have the same user ID “0001” and user name “yamax xrou”, four instructions of delivery refusal of electronic mail each of which includes different computer identification information in its text have been issued.

FIG. 4 shows an example of the data structure of the registration information DB 6. The registration information DB 6 stores the registration information about a computer identified by the computer identification information that is obtained from the DB of the Whois server R together with computer identification information corresponding to the registration information. The registration information is written in the registration information DB 6 when obtained by the registration information acquisition unit 3.

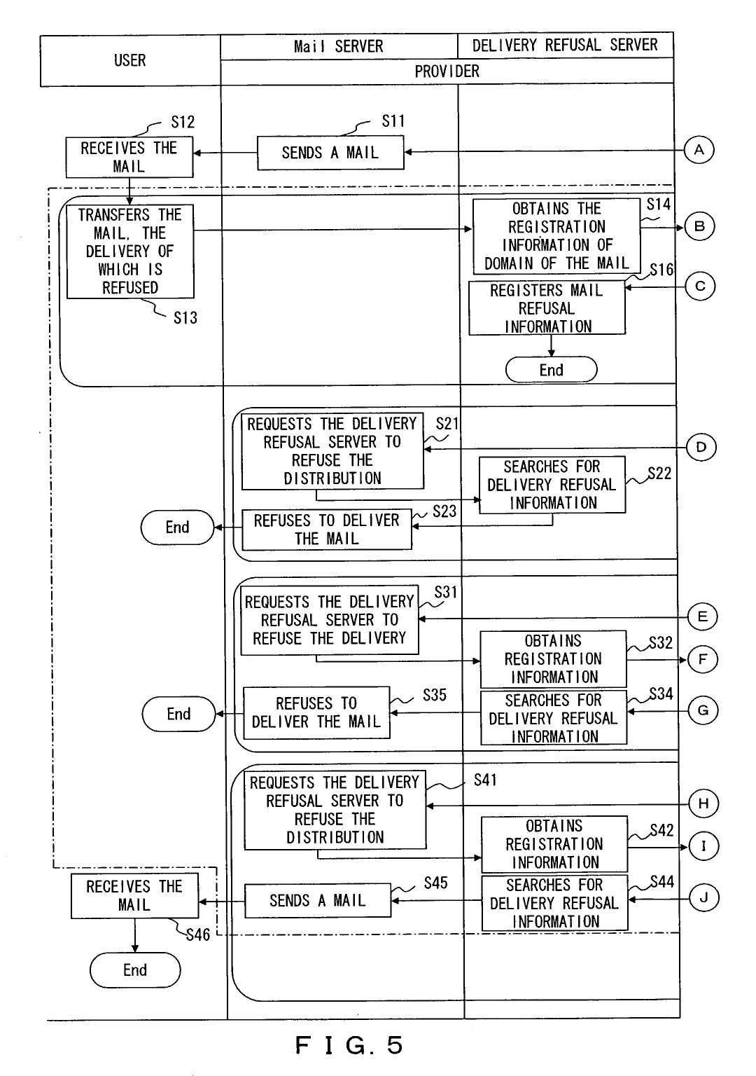

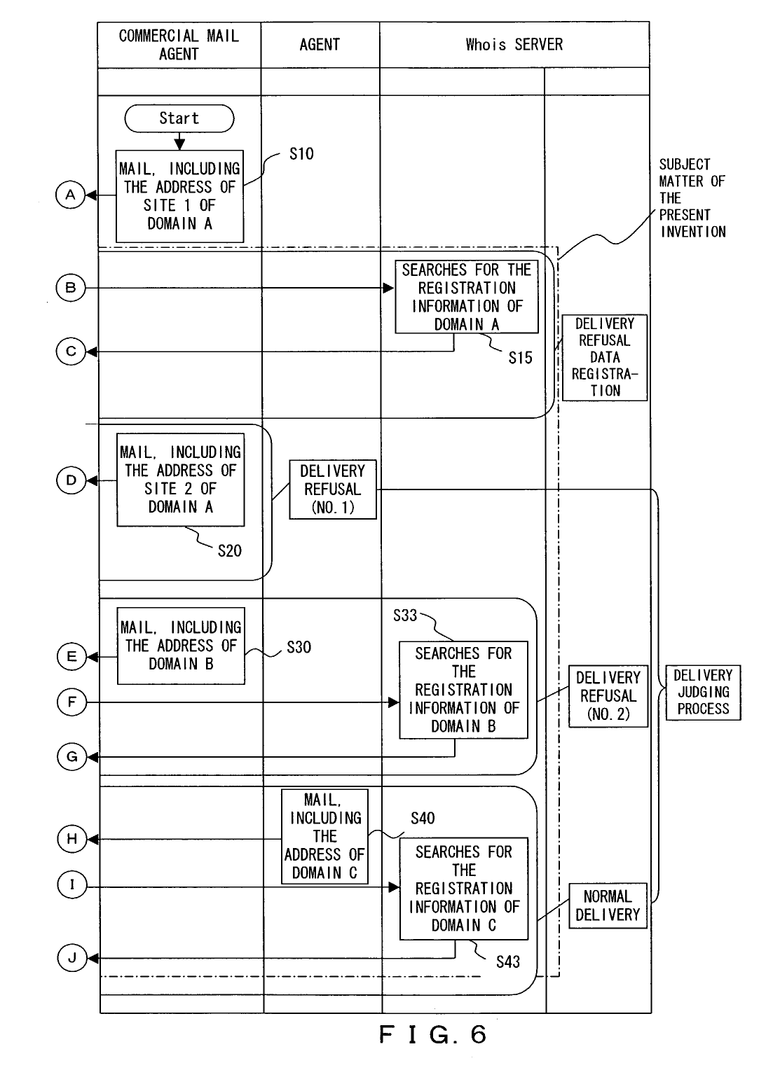

The process of the electronic mail delivery system shown in FIG. 1 is described below with reference to FIGS. 5 through 9. First, the rough process flow of the electronic mail delivery system is described with reference to FIGS. 5 and 6. FIGS. 5 and 6 are two halves obtained by dividing one flowchart into two, and the right ends of the flowchart shown in FIG. 5 and the left ends of the flowchart shown in FIG. 6 are to be connected at respective points each with the same symbol (A to J).

As shown in FIGS. 5 and 6, the processes of the electronic mail delivery system are largely grouped into two categories. One category is the process of registering each electronic mail, the delivery of which should be refused. The other category is the process of judging whether each electronic mail should be delivered to users Us.

First, the former process of registering each electronic mail, the delivery of which should be refused, is described. The former process corresponds to the “delivery refusal data registration” shown in FIGS. 5 and 6. The rough flow of this process is as follows. First, a user U receives an electronic mail from an agent through the mail server MSP of a provider P (steps S10 through S12). If the user U wants to refuse to receive future electronic mail from the same agent as the electronic mail, the user U instructs the provider P to refuse the delivery of the electronic mail and simultaneously transfers the electronic mail to the provider P (step S13). Then, the delivery refusal server DRS of the provider device P obtains registration information corresponding to the computer identification information from the Whois server R using the computer identification information extracted from the text of the electronic mail (steps S14 and S15). Then, the delivery refusal server DRS registers the extracted computer identification information and registration information in the delivery refusal DB 5 and registration information DB 6, respectively (step S16).

Next, the latter process of judging whether an electronic mail should be delivered is described. The results of the latter judgment process can be grouped into three cases. In the first case, computer identification information is extracted from a target electronic mail, and it is judged whether the electronic mail should be delivered, based on the extracted computer identification information. As one possible result, the electronic mail is not delivered. This case corresponds to the “delivery refusal (No. 1)” shown in FIGS. 5 and 6.

In the second case, if it cannot be judged whether the electronic mail should be delivered, based on only computer identification information, registration information corresponding to the extracted computer identification information is further obtained and it is again judged whether the electronic mail should be delivered, this time based on the obtained registration information. As one possible result, the electronic mail is not delivered. This case corresponds to the “delivery refusal (No. 2)” shown in FIGS. 5 and 6.

In the third case, if it cannot be judged whether the electronic mail should be delivered, based on only computer identification information, registration information corresponding to the extracted computer identification information is further obtained and it is again judged whether the electronic mail should be delivered, this time based on the obtained registration information. As a result, the electronic mail is delivered. This case corresponds to the “normal delivery” shown in FIGS. 5 and 6.

Each of the three cases is described in order below.

First, the rough flow of the process of the “delivery refusal (No. 1)” is described.

First, on receipt of an electronic mail from the commercial mail agent Q through the network N, the mail server MSP requests the delivery refusal server DRS to judge whether the electronic mail should be delivered and also sends the electronic mail to the delivery refusal server DRS (steps S20 and S21).

The delivery refusal server DRS retrieves delivery refusal data from the delivery refusal DB 5 using the recipient's address of the electronic mail and the computer identification information extracted from the text of the electronic mail as retrieval keys. Then, the delivery refusal server DRS judges whether the electronic mail should be delivered, based on the obtained computer identification information (step S22), and the mail server MSP refuses the delivery of the electronic mail, based on the result of the judgment (step S23).

Next, the rough flow of the process of the “delivery refusal (No. 2)” is described. This “delivery refusal (No. 2)” corresponds to the case where the delivery refusal server DRS judge that the electronic mail should be refused for delivery in step S22. Since steps S30 and S31 are the same as steps S20 and 21, their descriptions are omitted. Then, the delivery refusal server DRS retrieves data from the DB of the Whois server using the extracted computer identification information as a retrieval key and obtains registration information corresponding to the computer identification information (steps S32 and S33). Then, the delivery refusal server DRS judges whether the electronic mail should be delivered, based on the registration information obtained from the DB of the Whois server R and registration information obtained from the registration information DB 6 (step S34). Then, the mail server MSP refuses the delivery of the electronic mail, based on the result of the judgment (step S35).

This delivery refusal (No. 2) corresponds to the case where a commercial mail agent Q with a plurality of pieces of computer identification information sends a commercial mail to a user U using computer identification information other than one, that has been registered to be refused delivery.

Lastly, the rough flow of the process of the “normal delivery” is described. This normal delivery corresponds to the case where in step S34, the delivery refusal server DRS judges that an electronic mail should be delivered. Since steps S40 through S44 are the same as steps S30 through S34, their descriptions are omitted. After step S44, the mail server MSP delivers the electronic mail to the user U, based on the result of the judgment (step S45), and the user U receives the electronic mail (step S46).

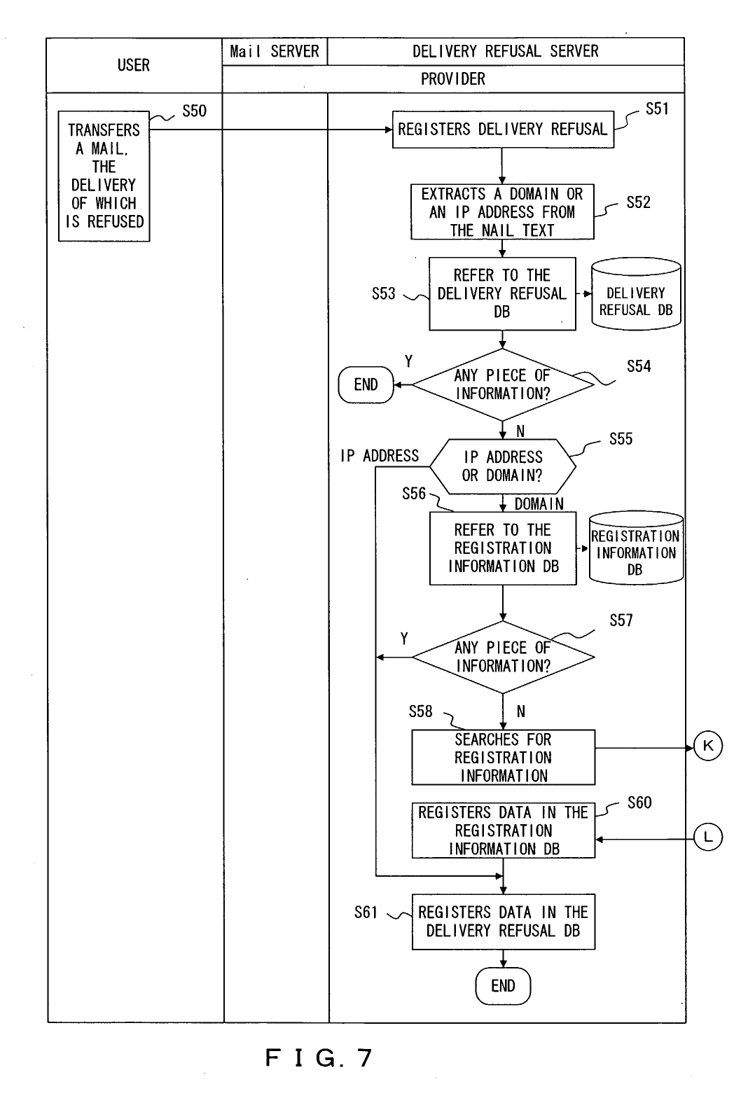

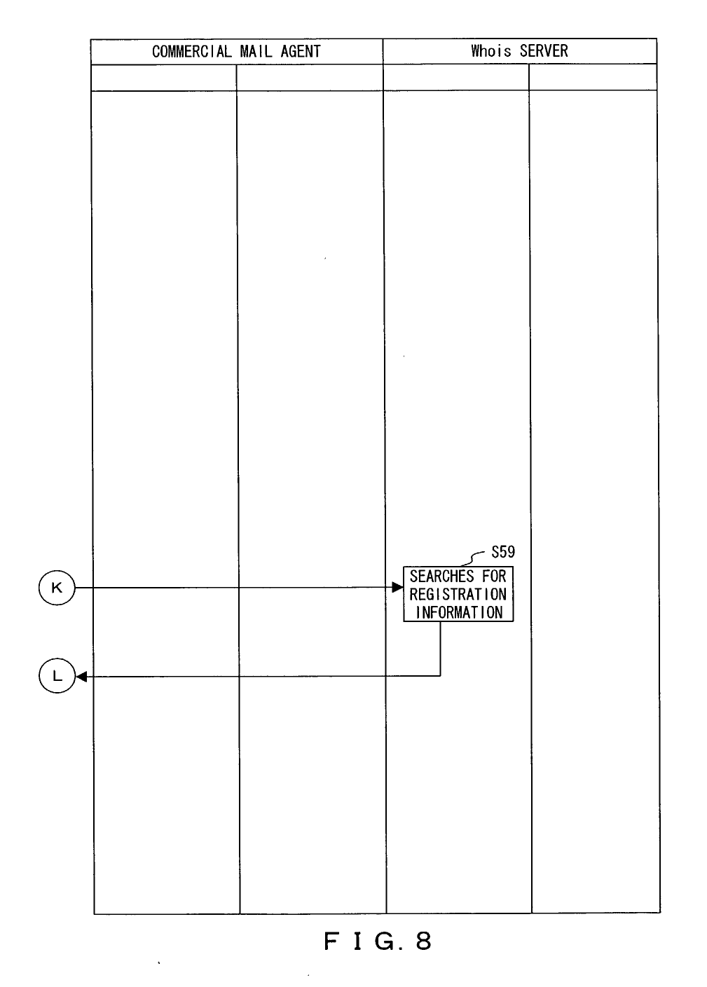

The above process is described in detail below. First, the procedure of the registration process of an electronic mail, the delivery of which is refused, is described in detail with reference to FIGS. 7 and 8. FIGS. 7 and 8 are obtained by dividing one flowchart into two like FIGS. 5 and 6, and the right ends of FIG. 7 and the left ends of FIG. 8 are to be connected at respective points each with the same symbols (K and L).

Although in the descriptions in FIGS. 7 and 8 and below, for computer identification information, an IP address and a domain are used, the computer identification information is not limited to them. Any piece of information other than these can be used as long as the information can specify a computer existing in a network.

First, a user U transfers an electronic mail that the user wants to refuse to receive, to the mail server MSP of the provider device P together with an instruction to refuse to receive it (step S50). The delivery refusal server DRS receives the electronic mail through the mail server MSP, and the delivery refusal registration unit of the delivery refusal server DRS starts its delivery refusal registration (step S51).

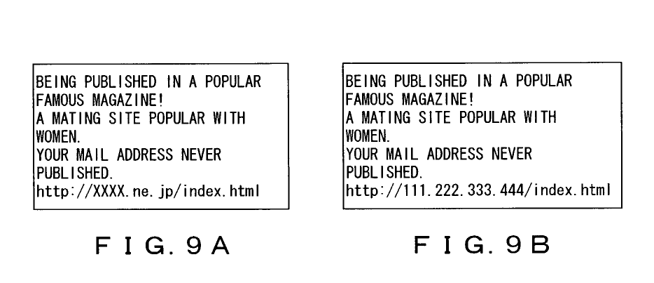

First, the computer identification information extracting unit 2 of the delivery refusal server DRS extracts computer identification information from the text of a received electronic mail (step S52). FIG. 9 shows an example of a commercial mail.

Most electronic mail, the reception of which is refused, is commercial mail. The aim of most of commercial mail are not to send electronic mail but to urge users to access a specific Web site. Therefore, most of the text of commercial mail includes information needed to access some Web page. For the information needed to access the Web page, a URL/URI representing the location in the network of the Web page, the IP address of a server that provides the Web page or the like, is used. FIG. 9A shows an example of the text of an electronic mail, including a URL, and FIG. 9B shows an example of the text of an electronic mail, including an IP address.

Most user terminals TU have a function to automatically recognize information needed to access a Web page, such as a URL in the text of an electronic mail or the like, even if the electronic mail is text mail. This function can be realized, for example, by detecting a character string, such as one starting http:// or the like included in the text. Inmost cases, if a user U selects (clicks, etc.) the URL in an electronic mail, the user terminal TU starts a Web client and displays a Web page represented by the URL or the like.

The computer identification information extracting unit 2 has the function to automatically recognize information needed to access the Web page. For example, if the information needed to access the Web page is a URL or an IP address, the computer identification information extracting unit 2 extracts computer identification information as follows, using the function.

If the information needed to access the Web page is a URL, the computer identification information extracting unit 2 extracts a domain included in a character string expressing a URL as computer identification information identifying a server (computer) that provides the Web page. A domain is the latter half of a server address and represents a company or organization. In the case of an American server address that ends with “.com”, “.edu”, “org” or the like, the last two blocks corresponds to the domain. In the case of another country's server address that ends with “.jp” or “.fr”, the last two or three blocks corresponds to the domain. For example, in the case of FIG. 9A, “xxxx.ne.jp” is extracted as computer identification information.

On the other hand, if the information needed to access the Web page is an IP address, the computer identification information extracting unit 2 extracts the IP address as computer identification information. For example, in the case of FIG. 9B, “111.222.333.444” is extracted as the computer identification information. Although in the following description, it is assumed that computer identification information is a domain or an IP address, the computer identification information is not limited to them.

Then, the delivery refusal registration unit 1 retrieves data from the delivery refusal DB 5 (step S53), and judges whether delivery refusal data with the same computer identification information and electronic mail address as the extracted computer identification information and the electronic mail address of the user U who issues the instruction, respectively, are stored in the delivery refusal DB 5 (step S54). If delivery refusal data meeting these conditions are stored in the delivery refused DB 5 (yes in step S54), the delivery refusal registration unit 1 terminates the registration process.

If delivery refusal data meeting the conditions are not stored in the delivery refusal DB 5 (no in step S54), the delivery refusal registration unit 1 judges whether the computer identification information is a domain or an IP address (step S55).

If the computer identification information is an IP address (IP address in step S55), the flow proceeds to step S61. In step S61, the delivery refusal registration unit 1 generates delivery refusal data, including the IP address and the user ID of the user U who issues the delivery refusal, the electronic mail address and the like, and writes the delivery refusal data in the delivery refusal DB 5. Then, the unit 1 terminates the process.

Although it is assumed above that if the computer identification information is an IP address, the flow proceeds to step S61 without obtaining registration information, steps S56 through S60, which are described later, can also be performed in order to obtain registration information, even if the computer identification information is an IP address.

If the computer identification information is a domain (domain in step S55), the delivery refusal registration unit 1 retrieves data from the registration information DB 6 (step S56), and judges whether registration information corresponding to the extracted computer identification information is stored in the registration information DB 6 (step S57).

If registration information corresponding to the extracted computer identification information is stored in the registration information DB 6 (yes in step S57), the flow proceeds to step S61. Otherwise (no in step S57), the registration information acquisition unit 4 obtains registration information corresponding to the computer identification information by retrieving data from the DB of the Whois server R using the computer identification information as a retrieval key (steps S58 and S59).

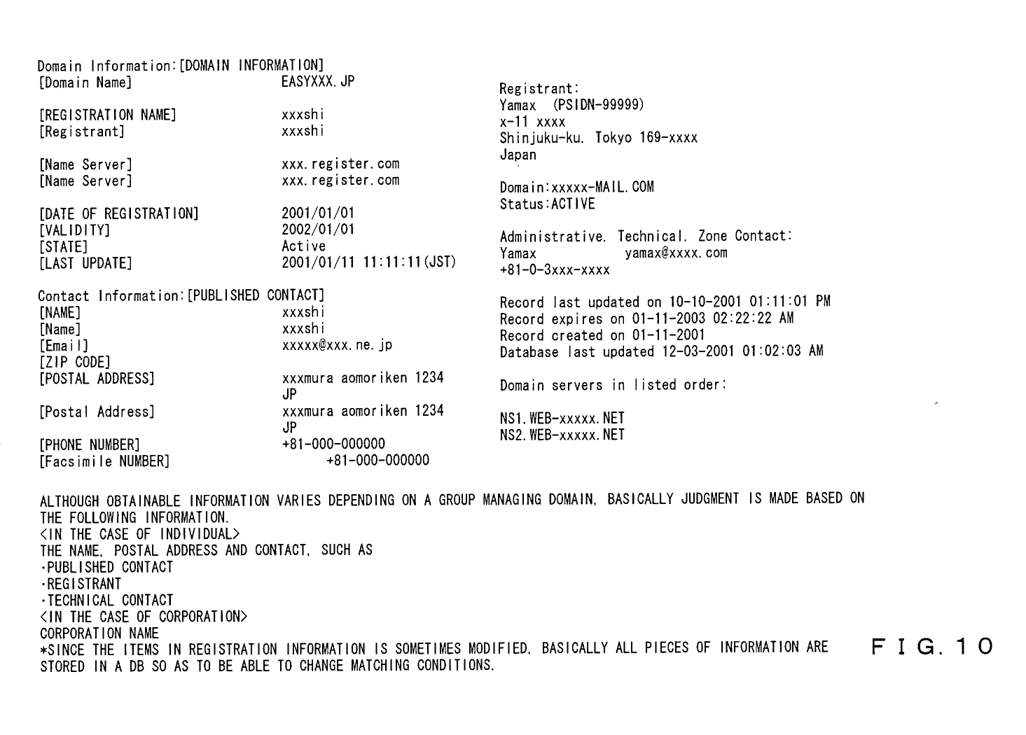

FIG. 10 shows an example of registration information obtained from the Whois server R. As shown in FIG. 10, registration information includes the domain name, the registrant of the domain name, the name of a domain name server, the date of registration, the validity of registered content and the like. In FIG. 10, the registrant name of domain name “EASYXXX.JP” is “xxxshi” and the domain name server corresponding to the domain name is “xxx.register.com”.

Since computer identification information and registration information are managed by the NIC and are stored in the DB of the Whois server R, a sender cannot modify these two pieces of information easily, unlike the sender's address of an electronic mail. The present invention judges whether an electronic mail should be delivered, based on the computer identification information and registration information.

Then, the registration information acquisition unit 3 writes the obtained registration information in the registration information DB 6 (step S60), and the flow proceeds to step S61. Since the items included in registration information is possible to be changed, basically all the pieces of obtained registration information may be written in the registration information DB 6.

Thus, an electronic mail, the delivery of which should be refused, is registered according to the instruction of the user U.

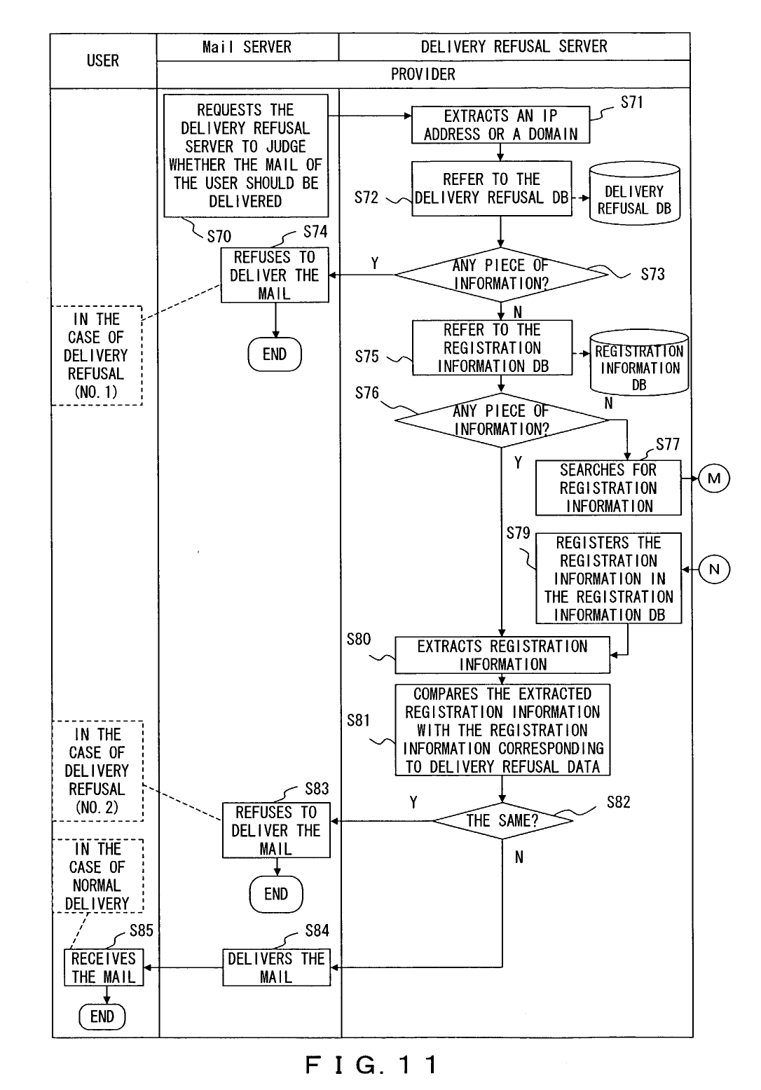

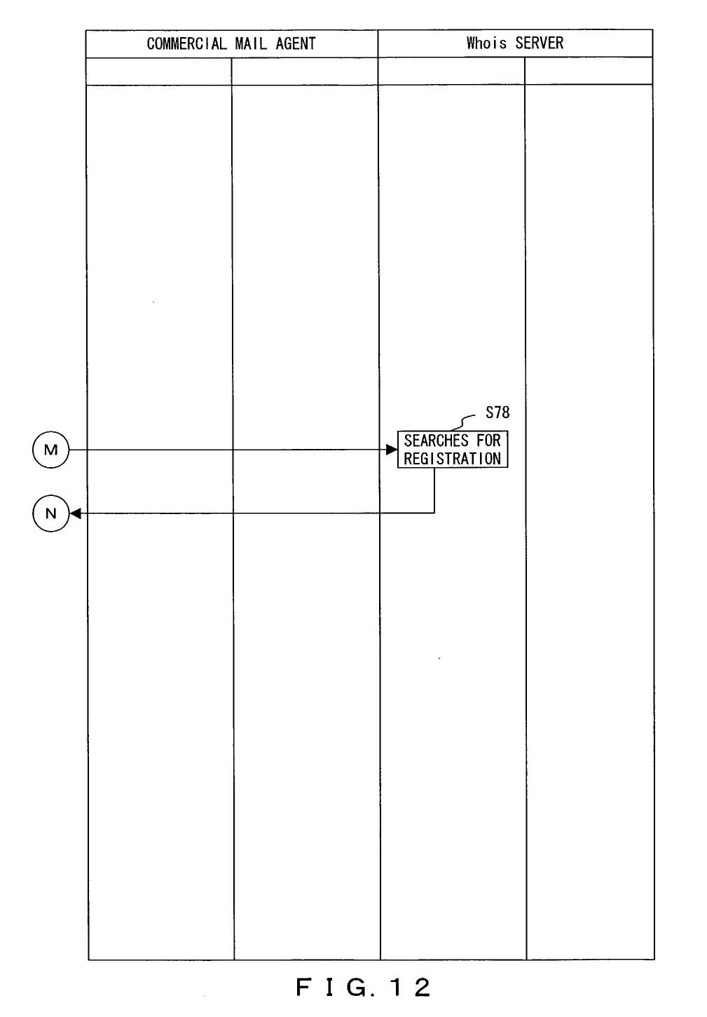

Next, the process for judging whether an electronic mail should be delivered is described in detail with reference to FIGS. 11 and 12. FIGS. 11 and 12 are obtained by dividing one flowchart into two like FIGS. 5 and 6, and the right ends of FIG. 11 and the left ends of FIG. 12 are to be connected at respective points each with the same symbol (M or N).

After the delivery refusal registration, basically all the electronic mails addressed to the user U are judged as follows.

First, on receipt of an electronic mail addressed to the user U, the mail server MSP instructs the delivery refusal server DRS to judge whether the electronic mail should be delivered (step S70). On receipt of the instruction, the delivery refusal server DRS starts judging whether the electronic mail should be delivered. The computer identification information extracting unit 2 of the delivery refusal server DRS extracts computer identification information from the text of the electronic mail in the same way as in step S51 (step S71). Then, the delivery refusal judgment unit 4 of the delivery refusal server DRS retrieves data from the delivery refusal DB 5 (step S72), and judges whether delivery refusal data With the same computer identification information and electronic mail address as the extracted computer identification information and the recipient's address of the electronic mail, respectively, are stored in the delivery refusal DB 5 (step S73). If delivery refusal data meeting the conditions are stored in the delivery refused DB 5 (yes in step S73), the delivery refusal judgment unit 4 judges that the delivery of the electronic mail should be refused (step S74) and terminates the process. This case corresponds to the delivery refusal (No. 1).

If delivery refusal data meeting the conditions are not stored in the delivery refusal DB 5 (no in step S73), the delivery refusal judgment unit 4 judges whether the computer identification information is a domain or an IP address. If the computer identification information is a domain, the flow proceeds to step S75. If the information is an IP address, the flow proceeds to step S84, which is described later, but which is not shown in FIG. 11.

This is because in the description of FIG. 5, it is assumed that if computer identification information is an IP address, registration information is not obtained. If registration information is obtained even if computer identification information is an IP address, steps S75 through S83, which are described later, are executed as in the case where computer identification information is a domain.

In step S75, the delivery refusal judgment unit 4 refers to the registration information DB 6, and judges whether registration information corresponding to the extracted computer identification information is stored in the registration information DB 6 (step S76). If registration information corresponding to the extracted computer identification information is stored in the registration information DB 6 (yes in step S76), the flow proceeds to step S80. Otherwise (no in step S76), the registration information acquisition unit 3 obtains registration information corresponding to the computer identification information as in steps S58 through S60, and writes the registration information in the registration information DB 6 (steps S77 through S79). Then, the flow proceeds to step S80.

In step S80, the delivery refusal judgment unit 4 extracts all pieces of delivery refusal data with the same electronic mail address as the recipient's address of an electronic mail to be judged, from the delivery refusal DB 5. Then, the delivery refusal judgment unit 4 extracts all pieces of registration information corresponding to computer identification information included in all the pieces of extracted delivery refusal data, from the registration information DB 6.

The delivery refusal judgment unit 4 compares the registration information extracted in step S80 with the registration information obtained in step S75 or S79 (step S81), and judges whether one or more pieces of registration information meeting prescribed matching conditions are included in the registration information obtained in step S75 or S79 (step S82).

More specifically, for example, if the prescribed condition is the “matching of registrant names”, the delivery refusal judgment unit 4 judges whether one or more registration information with the same registrant name as that of the registration information extracted in step S80 are included in the registration information obtained in step S75 or S79. The matching of registrant names is just one example. Any items included in the registration information, such as a publicly known contact, the name of a technological contact and the postal address/contact of a registrant can also be compared.

If a commercial mail agent Q, which is the sender of a mail, the delivery refusal of which is registered, has two different pieces of computer identification information and only one of them is stored in the delivery refusal DB 6, the judgment made based only on the computer identification information of the delivery refusal DB 5 will not refuse the delivery of a commercial mail, including computer identification information that is not stored in the delivery refusal DB 5, in its text.

However, since the registrants of these two pieces of computer identification information are the same commercial mail agent Q, in most cases, two pieces of information about a registrant and the like included in two pieces of registration information corresponding to two pieces of computer identification information coincide at least partially, for example, in a registrant name and the like. Therefore, even if computer identification information extracted from the text of an electronic mail being a judgment target is not stored in the delivery refusal DB 5, the delivery of commercial mails from a commercial mail agent Q with a plurality of pieces of computer identification information can be effectively refused by judging whether registration information corresponding to the computer identification information at least partially coincides with one of a plurality of pieces of registration information corresponding to a plurality of pieces of computer identification information stored in the delivery refusal DB 5.

If one or more pieces of registration information, at least part of which coincides with the registration information extracted in step S80, are included in the registration information obtained in step S75 or S79 (yes in step S82), the delivery refusal judgment unit 4 judges that the delivery of the electronic mail should be refused. Then, the mail server MSP refuses the delivery of the electronic mail (step S84) and terminates the process. This case corresponds to the delivery refusal (No. 2) described above.

Otherwise (no in step S82), the delivery refusal judgment unit 4 judges that the electronic mail should be delivered. In this case, the mail server MSP delivers the electronic mail to the user U (step S84) and the user U receives the electronic mail (step S85). Then, the process terminates.

Judgment on delivery refusal is described in detail below with reference to an example of the DBs shown in FIGS. 3 and 4. For convenience, the example an electronic mail is addressed to “yamax xrou”.

In the delivery refusal DB 5 shown in FIG. 3, a plurality of pieces of delivery refusal data with data IDs of one of 1 through 4 are registered for the user “yamax xrou”. The plurality of computer identification information included in the plurality of pieces of delivery refusal data are “xxxx.com”, “yyyyy.tv”, “zzzzz.ne.jp” and “aaaaa.nu”. First, if computer identification information extracted from an electronic mail being a judgment target coincides with at least one of the plurality of pieces of computer identification information, the delivery refusal judgment unit 4 judges that the electronic mail should be refused to be delivered.

In this case, if it is not judged that the delivery of the electronic mail should be refused, the delivery refusal judgment unit 4 further judges whether the delivery should be refused using registration information. Here it is assumed that the judgment is made using a registrant name included in the registration information. First, the delivery refusal judgment unit 4 extracts a plurality of pieces of registration information corresponding to “xxxx.com”, “yyyyy.tv”, “zzzzz.ne.jp” and “aaaaa.nu”, which are a plurality of pieces of computer identification information included in the delivery refusal data of “yamax xrou”. More specifically, in the registration information DB 6 shown in FIG. 4, a plurality of pieces of registration information with data IDs of one of 1 through 4 correspond to the four pieces of computer identification information. Registrant names included in the plurality of pieces of registration information are “aiueo”, “aiueo”, “kakikukeko” and “sasisuseso”, respectively. If the one of the registrant names included in the registration information corresponding to the computer identification information extracted from the electronic mail being a judgment target coincide with at least one of the three registrant names, the delivery refusal judgment unit 4 judges that the delivery of the electronic mail should be refused. Otherwise, the unit 4 judges that the electronic mail should be delivered.

Thus, the present invention judges whether the delivery of an electronic mail should be refused, based on computer identification information included in the text of an electronic mail and further based on registration information corresponding to the computer identification information, as requested.

According to the prior art, a user U who wants to refuse to receive an electronic mail, specifies to refuse the delivery of the electronic mail using the sender's address of an electronic mail. However, an agent sending commercial mails could send the refused electronic mail to the user again by modifying the sender's address of the electronic mail.

According to the prior art in which a user U designates the domain of an electronic mail to be received, electronic mails from a commercial mail agent with a plurality of domains couldn't be effectively refused, and furthermore, the senders of electronic mails that the user U could receive were restricted.

However, according to the present invention, by judging whether an electronic mail should be delivered, based on information, such as computer identification information and registration information, that is managed by a third party, such as the NIC, and that its sender cannot easily modify, the problems described above can be solved.

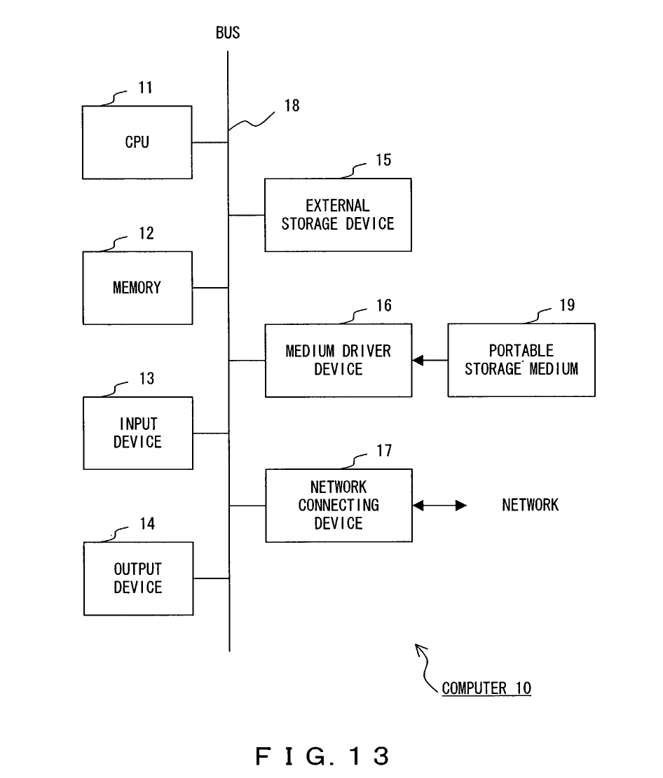

The user terminal TU, mail server MSP and delivery refusal server DRS described in the above preferred embodiments can be configured using a computer (data processing device) as shown in FIG. 10. As shown in FIG. 13, a computer 10 comprises a CPU 11, a memory 12, an input device 13, an output device 14, an external storage device 15, a medium driver device 16 and a network connection device 17, and the devices are connected to one another by a bus 18.

The memory 12 includes a ROM (read-only memory) and a RAM (random-access memory), and stores a program and data that are used for the process. The CPU 11 performs necessary processes by using the memory 12 and executing the program.

For example, if the delivery refusal server DRS is configured using the computer 10, the delivery refusal registration unit 1, computer identification information extracting unit 2, registration information acquisition unit 3 and delivery refusal judgment unit 4 of the delivery refusal server DRS are each stored in a specific program code segment of the memory 12 as a program. Alternatively, a program realizing each of the respective functions of the user terminal TU and mail server MSP can be stored in a specific program code segment of the memory 12 of the computer 10 as a program.

The input device 13 may be a button, a dial, a keyboard, a pointing device and/or a touch panel, and is used by a user to input instructions and information. The output device 14 may be a speaker, a display and/or a printer, and is used to output the results of processes to the user from the computer 10.

The external storage device 15 includes a magnetic disk device, an optical disk device and/or a magneto-optical disk device, and realizes the delivery refusal DB 5 and registration information DB 6. Further, the program can be stored in this external storage device 15, and can be used by loading the program to the memory 12, as requested.

The medium driver device 16 drives a portable storage medium 19 and accesses its recorded content. For the portable storage medium 19, an arbitrary computer-readable storage medium, such as a memory card, a memory stick, a flexible disk, a CD-ROM (compact-disk read-only memory), an optical disk, a magneto-optical disk, a DVD (digital versatile disk) or the like, is used. Further, the program can be stored in this portable storage medium, and can be used by loading the program into the memory 12, as requested.

The network connection device 17 communicates with an external device through an arbitrary network (line) N, such as a LAN, a WAN or the like, and transmits/receives data accompanying communication. Further, the program and data can be received from an external device and can be used by loading them into the memory 12, as requested.

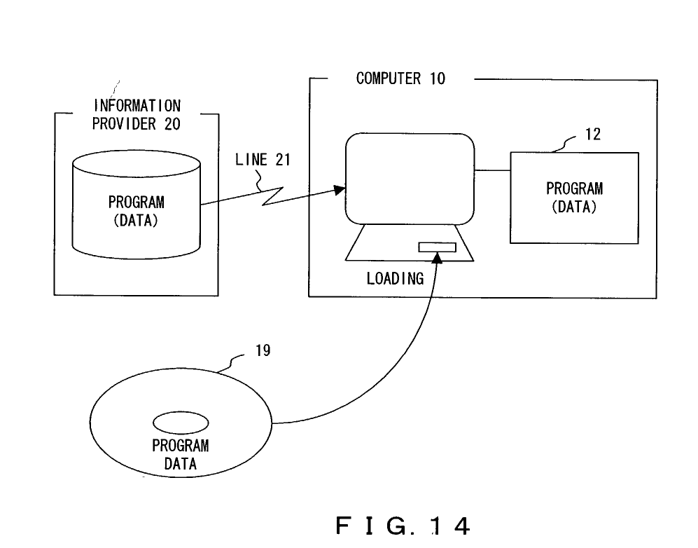

FIG. 14 shows computer-readable storage media and a transmission signal that provide the computer shown in FIG. 13 with the program and data.

The program and data which make a computer to realize the respective functions of the user terminal TU and mail server MSP or delivery refusal server DRS that are described in the above preferred embodiments can be loaded into the computer as described below. In that case, a plurality of programs enabling the computer to execute the respective processes performed by the user terminal TU, mail server MSP and delivery refusal DRS are created. Specifically, a program implementing the user terminal TU, a program implementing the mail server MSP and a program implementing the delivery refusal server DRS are created. Then, these programs are stored in advance in the computer-readable storage mediums 19. Then, as shown in FIG. 14, each of the programs is read from the storage medium 19 by the computer and is temporarily stored in the memory 12 or external storage device 15. Then, the CPU 11 of the computer 10 reads and executes the stored programs.

A signal that is transmitted through a line 21 when the program is downloaded to the computer 10 from an information provider 20 can also enable a general-purpose computer to realize a function corresponding to each of the user terminal TU, mail server MSP and delivery refusal server DRS that have been described in the above preferred embodiments.

Instead of a computer reading the program from the storage medium 19, the program can be downloaded from the database of the data provider 20 through the communication line (network) 21. In this case, for example, the computer of the information provider 20 obtains the transmission signal by converting program data representing the program into a program data signal and modulating the program data signal using a modem, and outputs the transmission signal to the communication line 21 (transmission medium). A receiving computer obtains the program data signal by demodulating the received transmission signal using a modem and obtains the program data by converting the program data signal. In this case, if the communication line 21 (transmission medium) connecting a transmitting computer and a receiving computer is digital, the program data signal can also be used instead of the transmission signal.

Although the preferred embodiments of the present invention have been described above, the present invention is not limited to the preferred embodiments described above, and a variety of modifications can also be applied.

For example, although a character string representing a domain has been expressed in alphabet, the present invention is applicable even in the case of characters other than alphabet, for example, the domain is expressed in Japanese characters.

Further, for example, the provider device P can also store in advance a variety of genres of information to be provided on a Web page in a database, and notifies a user U of the genre, to which the Web page belongs when the provider P sends an electronic mail, including information needed to access the Web page in its text to the user U.

In this case, the provider device P shown in FIG. 2 further comprises a genre notification unit and a Web page genre DB, which are not shown in FIG. 2. If the text of an electronic mail that the delivery refusal judgment unit 4 has judged to be delivered includes information needed to access the Web page, the genre notification unit retrieves data from the Web page genre DB, obtains the genre of information provided on the Web page and notifies the user U being the receiver of the genre. Thus, the user can judge whether the electronic mail should be delivered, based on the genre.

Furthermore, in the variation described above, a user can also register in advance a genre that the user wants to refuse to receive. In this case, the provider device P further comprises a delivery refusal genre DB storing genres that the user wants to refuse to receive, which is not shown in FIG. 2. In this configuration, the genre notification unit retrieves data from the Web page genre DB. Furthermore, the genre notification unit obtains the genre of information provided at the Web page from the Web page genre DB and judges whether the obtained genre is stored in the delivery refusal genre DB as a genre, the delivery of which should be refused. If the genre is stored in the DB, the genre notification unit refuses to deliver the electronic mail. Otherwise, the unit notifies the user U being the receiver, of the electronic mail of the genre.

As described above, according to the present invention, by extracting computer identification information identifying a computer in a network from the text of an electronic mail and judging whether the electronic mail should be delivered, based on the extracted computer identification information, the delivery of electronic mails that a user refuses to receive can be effectively prevented.

While the invention has been described with reference to the preferred embodiments thereof, various modifications and changes may be made to those skilled in the art without departing from the true spirit and scope of the invention as defined by the claims thereof.

What is claimed is:

1. An electronic mail delivery refusal judging method for judging whether an electronic mail should be delivered, comprising:
extracting a first computer identification information identifying a computer in a network from the text of a first electronic mail; and
judging whether the first electronic mail should be delivered, based on the extracted first computer identification information.

2. The electronic mail delivery refusal judging method according to claim 1, further comprising:
extracting a second computer identification information from the text of a second electronic mail; and
judging whether the first electronic mail should be delivered, based on the first and second computer identification information.

3. The electronic mail delivery refusal judging method according to claim 2, wherein
if the first and second computer identification information at least partially coincide, it is judged that the first electronic mail should not be delivered.

4. The electronic mail delivery refusal judging method according to claim 2, further comprising:
obtaining a first registration information about a computer in a network, based on the first computer identification information;
obtaining a second registration information about a computer in a network, based on the second computer identification information; and
judging whether the first electronic mail should be delivered, based on the first and second registration information.

5. The electronic mail delivery refusal judging method according to claim 4, wherein
the first and second registration information can be obtained using a Whois protocol.

6. The electronic mail delivery refusal judging method according to claim 4, wherein
if the first and second registration information at least partially coincide, it is judged that the first electronic mail should not be delivered.

7. The electronic mail delivery refusal judging method according to claim 1 or 6, wherein
said computer identification is a domain or an Internet protocol address.

8. A computer-readable storage medium on which is recorded a program enabling a computer to execute a process, said process comprising:
extracting a first computer identification information identifying a computer in a network from text of a first electronic mail; and
judging whether the first electronic mail should be delivered, based on the extracted first computer identification information.

9. An electronic mail delivery refusal judging device, comprising:
a computer identification information extracting unit extracting a first computer identification information identifying a computer in a network from text of a first electronic mail; and
a delivery refusal judging unit judging whether the first electronic mail should be delivered, based on the extracted first computer identification information.

10. An electronic mail delivery refusal judging device, comprising:
computer identification information extracting means for extracting a first computer identification information identifying a computer in a network from text of a first electronic mail; and
delivery refusal judging means for judging whether the first electronic mail should be delivered, based on the extracted first computer identification information.

11. An electronic mail receiving method, wherein
a first computer sends the text of a first electronic mail to a second computer, and
the first computer receives a second electronic mail that a second computer judges to be delivered based on computer identification information identifying a computer in a network, that is extracted from text of the first electronic mail.
